(19) United States
(12) Patent Application Publication
(10) Pub. No.: US 2015/0331084 A1
(43) Pub. Date: Nov. 19, 2015

(54) DEVICE AND METHOD FOR MEASURING POSITION OF ELECTRONIC DEVICE

(71) Applicant: Samsung Electronics Co., Ltd., Gyeonggi-do (KR)

(72) Inventors: Kyung Tae KIM, Gyeonggi-do (KR); Seung Eun LEE, Seoul (KR); Jeong Min PARK, Gyeonggi-do (KR); Eun Jung HYUN, Seoul (KR)

(21) Appl. No.: 14/712,149

(22) Filed: May 14, 2015

(30) Foreign Application Priority Data
May 14, 2014 (KR) 10-2014-0057989

(51) Int. Cl. G01S 5/02; G10K 11/26; H04B 11/00; G01S 5/22

(52) U.S. Cl. CPC G01S 5/0257; G01S 5/0284; G01S 5/22; G10K 11/26; H04B 11/00

(57) ABSTRACT

Apparatuses, systems, and methods for an electronic device to detect the relative position of another electronic device are described. One electronic device includes a communication unit, at least two microphones, and a control unit. The electronic device generates signal information by which another electronic device may generate an output signal which can be detected by the microphones. The signal information is transmitted via the communication unit to the other electronic device. If the output signal is obtained by the microphones, the electronic device determines a relative position of the other electronic device, based on the obtained output signal.

### PRIORITY

This application claims priority under 35 U.S.C. §119(a) to a Korean Patent Application filed on May 14, 2014 in the Korean Intellectual Property Office and assigned Serial No. 10-2014-0057989, the entire disclosure of which is hereby incorporated by reference.

### BACKGROUND

1. Field of the Disclosure

The present disclosure relates generally to an electronic device capable of position measuring and, more particularly, to methods, devices, and systems for an electronic device to measure the relative position/directions of other electronic devices connected via a communication network.

2. Description of the Related Art

The position of an electronic device can be determined using satellites, such as by using the Global Positioning System (GPS), or by a triangulation method using distances from the electronic device to known base stations.

However, when an electronic device uses the triangulation method to measure the position of other electronic devices, the position data obtained may suffer from a lack of accuracy.

Therefore, there is a need for apparatuses, systems, and methods for an electronic device to determine the relative positions/directions of other electronic devices.

### SUMMARY

The present disclosure has been made to address at least the problems and/or disadvantages described above and to provide at least the advantages described below.

According to an aspect of the present disclosure, an electronic device is provided which can generate signal information for a signal desired to be output from at least one other electronic device, transmit that signal information to the at least one other electronic device, and then determine a relative position/direction of the at least one other electronic device using the signal output from the at least one other electronic device based on the signal information.

According to another aspect of the present disclosure, it is possible to determine relative positions/directions among a plurality of electronic devices.

According to another aspect of the present disclosure, an electronic device may actively generate signal information, which is associated with a signal desired to be output by the electronic device, based on information on noise signal around the electronic device.

According to an aspect of the present disclosure, an electronic device capable of determining a relative position of at least one other electronic device is provided, including a communication unit; at least two microphones; and a control unit which generates signal information by which another electronic device may generate an output signal to be detected by the microphones, controls the communication unit to transmit the signal information to the other electronic device, and, if the output signal is obtained by the microphones, determines a relative position of the other electronic device, based on the output signal obtained by the sensor unit

According to another aspect of the present disclosure, a method for an electronic device to determine a relative position of at least one other electronic device is provided, including generating, by the electronic device, signal information by which another electronic device may generate an output signal to be detected by the electronic device; transmitting the signal information to the other electronic device; receiving the output signal generated using the signal information from the other electronic device; and determining a relative position of the other electronic device based on the received output signal

According to yet another aspect of the present invention, a non-transitory computer-readable storage medium is provided, which has one or more instructions which, when executed by a processor of an electronic device, causes the electronic device to perform the steps of generating signal information by which another electronic device may generate an output signal to be detected by the electronic device; transmitting the signal information to the other electronic device; receiving the output signal generated using the signal information from the other electronic device; and determining a relative position of the other electronic device based on the received output signal

### BRIEF DESCRIPTION OF THE DRAWINGS

The above and other aspects, features, and advantages of certain embodiments of the present disclosure will become more apparent from the following description taken in conjunction with the accompanying drawings, in which:

FIG. 1 is a schematic diagram illustrating an example of a system for measuring the position of other electronic devices, according to an embodiment of the present disclosure;

FIG. 2 is a block diagram of relevant components in an electronic device, according to an embodiment of the present disclosure;

FIG. 3 is a flow chart of a method for an electronic device to determine the relative position/direction of another electronic device, according to an embodiment of the present disclosure;

FIG. 4 is a flow chart of a method for an electronic device to determine the relative position/direction of another electronic device, according to another embodiment of the present disclosure;

FIG. 5 is a flow chart of a method for an electronic device to determine the relative position/direction of another electronic device, according to still other embodiment of the present disclosure;

FIGS. 6A and 6B illustrate examples in which a position/direction determining method according to an embodiment of the present disclosure is used to display an image across the screens of several electronic devices;

FIG. 7 is a schematic diagram illustrating an example of a plurality of electronic devices determining their relative positions/directions, according to an embodiment of the present disclosure;

FIG. 8 is a flow chart illustrating a method of determining relative positions/directions of a plurality of electronic devices, according to an embodiment of the present disclosure;

FIG. 9 is a flow chart illustrating a method of determining relative positions/directions of a plurality of electronic devices, according to another embodiment of the present disclosure; and

FIG. 10 is a flow chart illustrating a method of determining relative positions/directions of a plurality of electronic devices, according to still another embodiment of the present disclosure.

### DETAILED DESCRIPTION OF EMBODIMENTS

Embodiments of the present disclosure will now be described in detail with reference to the accompanying drawings. Various modifications are possible in various embodiments of the present disclosure and embodiments are illustrated in drawings and related detailed descriptions are listed. However, this is not intended to limit the scope of the present disclosure to a specific embodiment, and it should be construed that the present disclosure covers modifications and variations of this disclosure within the scope of the appended claims and their equivalents. With respect to the drawings, like reference numerals may be used to depict the same or similar elements, features, and structures.

The terms “include,” “comprise,” “including,” “comprising” or “having” may be used herein to indicate disclosed functions, operations, or existence of elements, but should not be interpreted to exclude other functions, operations or elements. The meaning of the term “or” or “at least one of A and/or B” used herein includes any combination of elements listed together with the term. For example, the expression “at least one of A and/or B” indicates A, B, and both A and B.

It will be understood that when an element is referred to as being “connected” or “coupled” to another element, it can be directly connected or coupled to the other element or intervening elements may be present. In contrast, when an element is referred to as being “directly connected” or “directly coupled” to another element, it should be understood that there are no intervening elements.

It is to be understood that the singular forms “a,” “an,” and “the” include plural referents unless the context clearly dictates otherwise.

The terms used herein, including technical or scientific terms, have the same meanings as understood by those skilled in the art. It should be further understood that terms in common usage should also be interpreted as is customary in the relevant art and not in an idealized or overly formal manner unless expressly so defined herein.

An electronic device according to various embodiments of the present disclosure is configured for communication with other devices, and may be a wireless communication device, such as, for example, a smartphone, a tablet personal computer (PC), a mobile phone, a personal digital assistant (PDA), a Motion Picture Experts Group (MPEG-1 or MPEG-2) Audio Layer 3 (MP3) player, a wearable device (e.g., a smart watch, electronic glasses, or a head-mounted-device (HMD)), cameras, and the like.

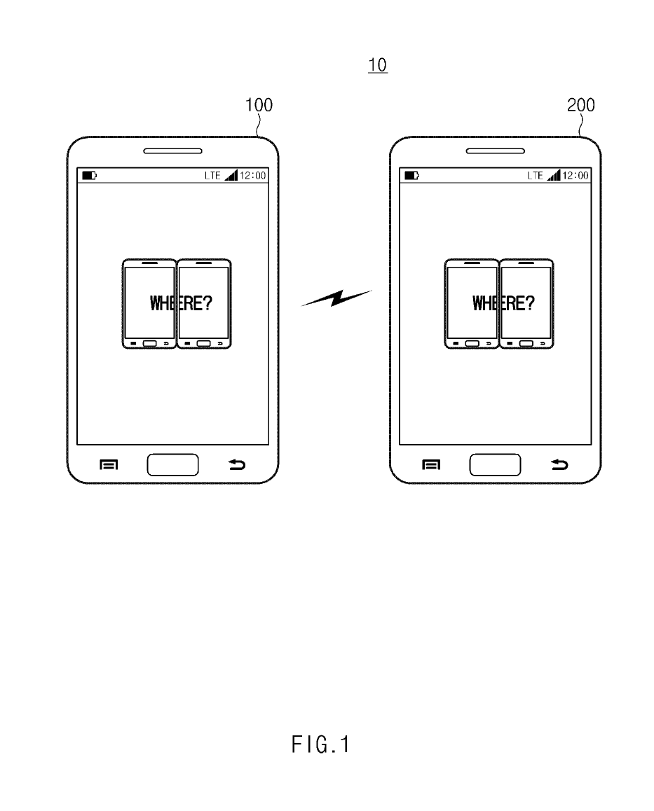

FIG. 1 is a schematic diagram illustrating an example of a system for measuring the position of other electronic devices, according to an embodiment of the present disclosure. FIG. 1 shows first electronic device 100 and second electronic device 200.

The first electronic device 100 determines the relative position of the second electronic device 200, i.e., its position with respect to the first electronic device 100, using at least two sensors. The first electronic device 100 and the second electronic device 200 can communicate with each other. According to an embodiment of the present disclosure, the first electronic device 100 generates signal information and transmits it to the second electronic device 200. The signal information contains specific information, which is used by the second electronic device 200 to generate its own signal. The signal generated by the second electronic device 200 is output and received or obtained by the first electronic device 100.

The first electronic device 100 determines the relative position of the second electronic device 200 based on the signal received from, and generated by, the second electronic device 200. More specifically, the first electronic device 100 analyzes the received signal, and, based at least partially on that analysis, determines a relative direction and/or a relative angle of the second electronic device 200 with respect to the first electronic device 100.

When the second electronic device 200 receives the signal information from the first electronic device 100, it checks for the specific information contained in the signal information. The second electronic device 200 generates and outputs its own signal based on the checked specific information. The second electronic device 200 may compress and output its generated signal, but, in any event, the signal generated by the second electronic device 200 is distinguishable from other signals, whether generated by the first electronic device 100 or by another source in the vicinity of the second electronic device 200. The signal may comprise a sinusoidal signal with frequency information, such as an acoustic/sound signal or a radio/electromagnetic signal.

Each of the first electronic device 100 and the second electronic device 200 are capable of generating the signal information or generating and outputting a signal based on received signal information.

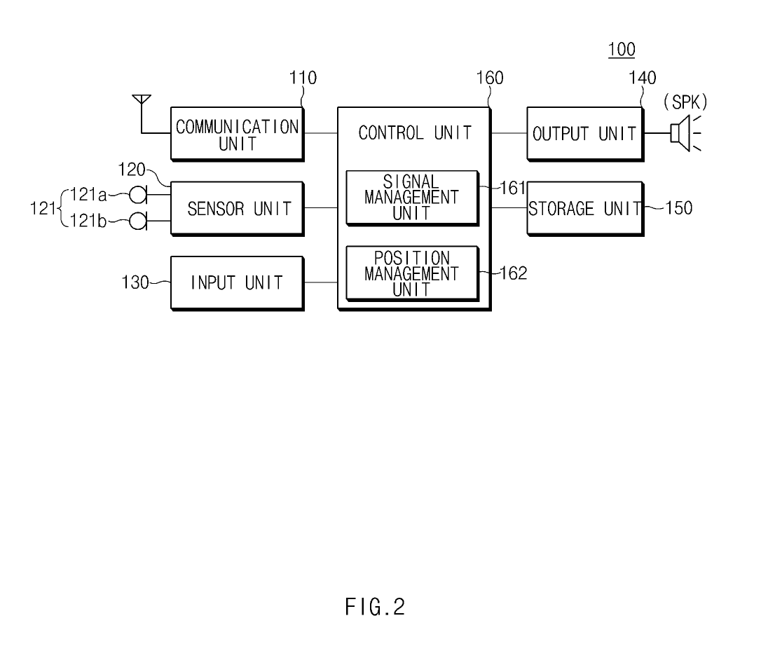

FIG. 2 is a block diagram of an electronic device, according to an embodiment of the present disclosure. In this instance, the electronic device is the first electronic device 100 from FIG. 1. First electronic device 100 includes a communication unit 110, a sensor unit 120, an input unit 130, an output unit 140, a storage unit 150, and a control unit 160.

The communication unit 110 enables communication between the first electronic device 100 and any external electronic devices (e.g., a server or second electronic device 200 from FIG. 1). The communication unit 110 may connect with the external electronic device via a wireless or wired communication. The wireless communication may be based on at least one of, for example, Wi-Fi (based on IEEE 802.11 standards), Bluetooth (BT), Near Field Communication (NFC), and/or cellular communication (e.g., long term evolution (LTE), LTE-advanced (LTE-A), Code Division Multiple Access (CDMA), Wideband CDMA (WCDMA), Universal Mobile Telecommunication System (UMTS), Wireless Broadband (WiBro), and/or Global System for Mobile Communications (GSM)). The wired communication may be based on at least one of, for example, Universal Serial Bus (USB), High Definition Multimedia Interface (HDMI), Recommended Standard 232 (RS-232), and/or Plain Old Telephone Service (POTS).

Furthermore, the communication unit 110 may provide a voice call service, a video call service, a chat message service, a short message service, a multimedia message service, or an Internet service via the cellular communication. The communication unit 110 may receive image data (for example, still image data or video data) from an external device using wireless and/or wired communication.

The sensor unit 120 includes a microphone sensor 121 comprising two microphones 121a and 121b, which are configured to sense audio/sound signals output from the second electronic device 200 and provide the obtained signals to the control unit 160.

The input unit 130 receives input from the outside, generates an operation signal for operating the first electronic device 100 based on the input, and provides the operation signal to the control unit 160. By means of input unit 130, an operation signal may be generated requesting a communication connection with the second electronic device 200. For purposes of convenience, the communication connection between the first and second electronic devices in the description that follows will be a wireless communication connection; however, embodiments of the present disclosure are limited thereto. By means of the input unit 130, a user may generate a signal requesting production of signal information to be transmitted to the second electronic device 200. To obtain ambient audio/sound signals from around the first electronic device 100, a user may use the input unit 130 to generate a signal requesting activation of the sensor unit 120, including the two microphones 121a and 121b. The input unit 130 may comprise any type of suitable input device, including, but not limited to, at least one of one or more buttons or keys, a keyboard, a keypad, a touchpad, a touch screen, or the like.

The output unit 140 may comprise a display under the control of the control unit 160, such as a liquid crystal display (LCD), a touch screen, and/or the like. If the output unit 140 comprises a touch screen, the output unit 140 also serves as an input, which could be considered a part of input unit 120 as well. For example, if the touch screen displays a virtual button, thereby allowing a user to input an input signal, at least part of the output unit 140 is serving as an input, and thus, could be considered a part of the input unit 130. The output unit 140 includes a speaker (SPK) for outputting an audio/sound signal corresponding to received signal information, under the control of the control unit 160. In embodiments using radio/electromagnetic signals rather than audio/sound signals, those signals may be output by, for example, one or more antennas of communication unit 110.

The storage unit 150 may store one or more programs, applications, and/or the like for operating the first electronic device 100. The storage unit 150 stores at least one algorithm for analyzing one or more signals output from the second electronic device 200 based on received signal information. For example, the algorithm may be implanted using one or more of a direction of arrival (DOA) estimation method, a time delay of arrival (TDOA) estimation method, a beam scanning method, and a generalized cross correlation-phase transform (GCC-PHAT) method. An electronic device according to an embodiment of the present disclosure stores information on the other, wirelessly-connected electronic device (such as, e.g., a device or (Medium Access Control) MAC address, a pin code, and/or a device type), and this information may be stored in storage unit 150 or some type of temporary or operating storage, depending on the specific implementation.

The control unit 160 can generate signal information to be provided to another electronic device for generating and outputting a signal, which, when received, is checked/analyzed by the control unit 160. The control unit 160 determines a relative position and/or angle of the other electronic device based on the checked/analyzed signal. For this analysis, control unit 160 includes signal management unit 161 and position management unit 162 in this embodiment of the present disclosure.

If a request for the production of signal information is received from another electronic device, the signal management unit 161 generates the signal information to be transmitted to the other electronic device 200. The signal information may contain information on, for example, the frequency of the signal which the other electronic device will generate and output for reception. The control unit 161 may control the generated signal information to be transmitted through the communication unit 110 to the second electronic device 200. The signal management unit 161 may check, analyze, and/or process the signal output from the other electronic device 200 and received through the sensor unit 120. After this, the signal management unit 161 provides the checked/analyzed/processed signal to the position management unit 162.

In an embodiment of the present disclosure, the signal management unit 161 limits the frequency band of the signal received from the other electronic device. In one embodiment of the present disclosure, the signal management unit 161 generates the signal information to contain information on the desired frequency band. In another embodiment, the signal management unit 161 applies a band-pass filter (BPF) to the received signal and provides the filtered signal to the position management unit 162.

The signal management unit 161 (or, equivalently, control unit 160) can activate the sensor unit 120 to obtain ambient signals in the vicinity of the electronic device. The signal management unit 161 checks/analyzes/processes the one or more ambient signals (comprising, e.g., a plurality of frequency components) received through the activated sensor unit 120 and determines information, such as frequency, concerning the signal desired to be received from the other electronic device. From this information, the signal management unit 161 generates the signal information. As an example of such analysis and determination, the signal management unit 161 may calculate a power spectral density (PSD) of the ambient signal(s) around the electronic device and then determine a frequency band having a value smaller than a specified critical value, based on the calculated PSD, in which the other electronic device should transmit its signal. In order to avoid reception failure of the signal output from the other electronic device, the electronic device may select a frequency band which can be easily obtained/received by the sensor unit 120.

The signal information generated by the signal management unit 161 is transmitted to the second electronic device 200 through the communication unit 110. The signal management unit 161 may also check/analyze/process the signal which is output from the other electronic device 200 and provide the checked/analyzed/processed signal to the position management unit 162. Here, the signal desired to be received from the other electronic device may be on a frequency absent from the ambient signal(s) surrounding the electronic device or may be on a frequency on which the weakest ambient signal(s) are present. By these and other methods known to those of ordinary skill in the art, a signal best suited for reception and use by the electronic device for determining a relative position/angle of the other electronic device may be determined in order to, for example, avoid confusion.

When the checked/analyzed/processed signal is provided by the signal management unit 161, the position management unit 162 calls one or more of the one or more algorithms stored in the storage unit 150 to determine a position of the other electronic device. According to an embodiment of the present disclosure, the position management unit 162 uses a direction of arrival (DOA) estimation algorithm to estimate the output direction of the received signal and determine a relative position of the other electronic device. The position management unit 162 may use, for example, methods such as GCC-Phat, beam scanning, multiple signal classification (MUSIC), or estimation of signal parameters via rotational invariance technique (ESPRIT).

Using, in this example, the MUSIC method, the position management unit 162 calculates an angle giving the highest value of P(θ) from signals received by the two sensors, i.e., microphones 121a and 121b, using, e.g., the following equation 1. The position management unit 162 determines a relative direction of the other electronic device with respect to the electronic device, based on the calculated angle. In the following equation 1, a(θ) represents the steering angle between the signals received by the two sensors 121a and 121b. Uₙ is a matrix representing the ambient signal space of the electronic device, not for the signal received from the second electronic device 200. For example, Uₙ may be a matrix consisting of eigenvectors associated with at least one smallest eigenvalue obtained using a correlation matrix of the measured ambient signal(s).

$$P ( θ ) = \frac{1}{\vert {a}^{H} ( θ ) {U}_{n} {U}_{n}^{H} a ( θ ) \vert} \qquad Equation ( 1 )$$

Using, in this example, the ESPRIT method, the position management unit 162 calculates an arrival angle of the signal received from the other electronic device using, e.g., the following equation 2) Here, three sensors are required, e.g., the two sensors 121a and 121b and another sensor (not shown), spaced apart from each other by the same interval. The position management unit 162 calculates the arrival angle using signals received by the three sensors. The position management unit 162 determines a relative direction of the signal output from the other electronic device, with respect to the electronic device, based on the calculated arrival angle, and determines the direction of the other electronic device with respect to the electronic device. In equation 2, c is the speed of light and d is the spatial distance between adjacent sensors. θ is a diagonal matrix representing the phase delays between the sensors.

$$θ = {sin}^{- 1} [ \frac{c}{d ω} arg ( θ ) ] \qquad Equation ( 2 )$$

In this example, the position management unit 162 uses a TDOA estimation algorithm stored in, e.g., the storage unit 150, to estimate a feature value (e.g., a delay time in signal receiving) of the received signal, and to determine an output direction and a position of the other electronic device which output the signal. The position management unit 162 calculates a cross-correlation function between signals received by the two sensors 121a and 121b using the TDOA estimation method, as given by equation 3 below, and uses the calculated cross correlation to estimate a phase response of the signal. In equation 3, G(f) may represent the frequency band of the cross-correlation function between the received signals. The position management unit 162 determines the position of the other electronic device with respect to the electronic device from the group delay calculated from the phase response of the signal. Furthermore, the resulting value calculated using equation 3 may be transformed to the time domain through the inverse fast Fourier transform (IFFT), and a cross-correlation function for the phase signal may be calculated. The use of the cross-correlation function for the phase signal may make it possible to calculate a delay value between the two sensors, and the calculated delay value may be used to determine the direction of the other electronic device with respect to the electronic device.

$$\overline{G} ( f ) = \frac{G ( f )}{\vert G ( f ) \vert} \qquad Equation ( 3 )$$

In this example according to an embodiment of the present disclosure, the position management unit 162 uses a beam scanning algorithm to generate a steering vector corresponding to the steering angle intended to be measured. The generated steering vector is used to calculate reception gains of the signals received by the sensors 121a and 121b and to detect an incident angle giving the highest value of the reception gain. The position management unit 162 calculates a reception gain from the steering vector, a(θ), and the autocorrelation matrix, Rₓₓ, of the received signal, as given by equation 4. Here, c may be an arbitrary constant. The position management unit 162 determines the relative direction of the other electronic device from the incident angle giving the highest value for the reception gain. Here, the electronic device is used as a reference point to describe the direction of the other electronic device. The position management unit 162 utilizes the frequency information, which was in the signal information transmitted to the other electronic device, to generate the steering vector.

p(θ)=c*(a^{H}*Rₓₓ*a(θ)) Equation (4)

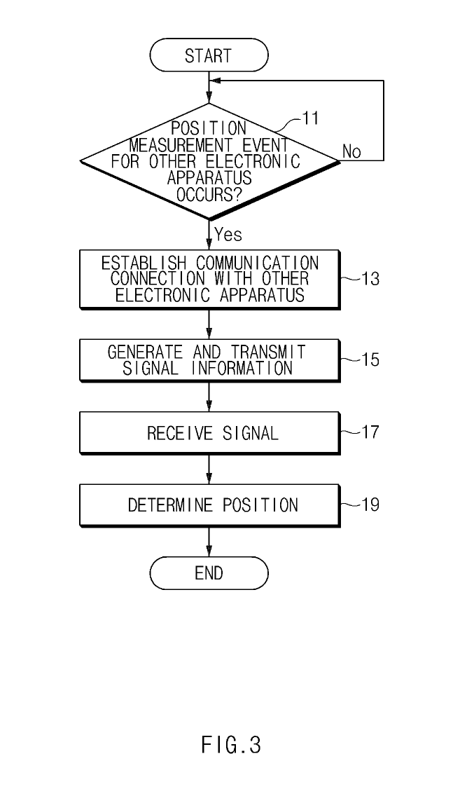

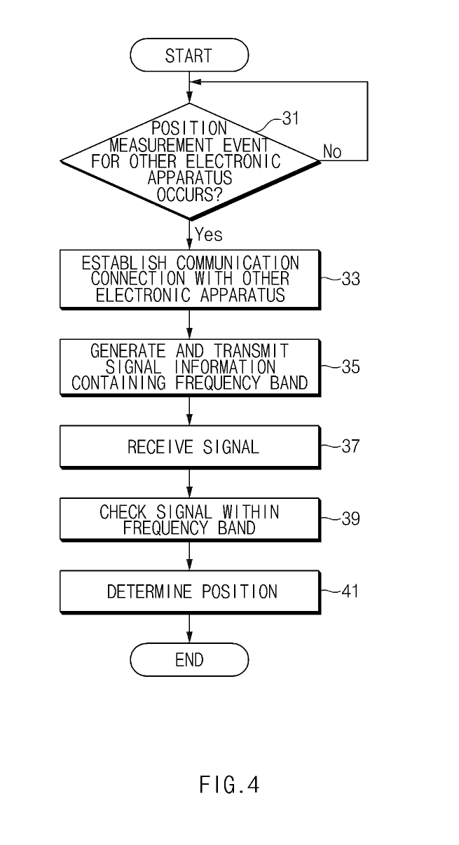

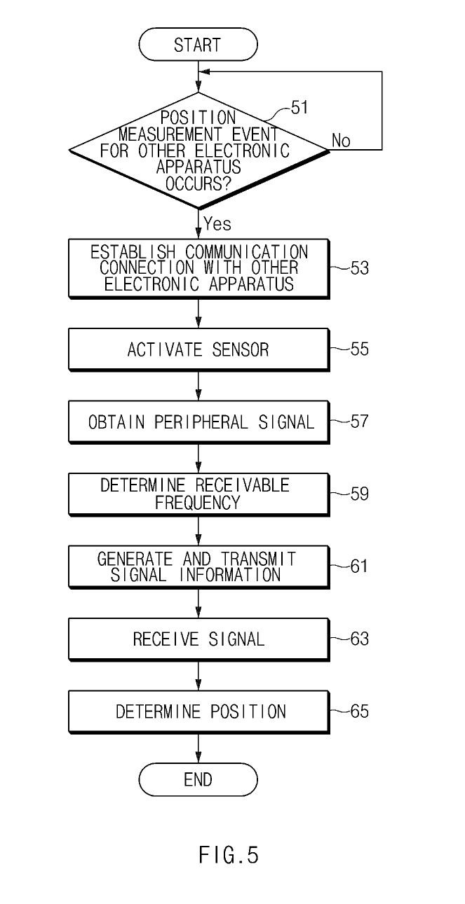

FIG. 3 is a flow chart of a method for an electronic device to determine the relative position/direction of another electronic device, according to an embodiment of the present disclosure. In step 11 of FIG. 3, it is determined if there has been an event requiring and/or requesting measurement of the relative position/direction of another electronic device (for convenience of reference, the electronic device performing the steps in this and FIGS. 4 and 5 will be first electronic device 100 and the other electronic device will be second electronic device 200), such as, for example, a user requesting such through the input unit 130. If such an event occurs in step 11, the method proceeds to step 13; otherwise, the method loops back.

In step 13, the control unit 160 connects to the second electronic device 200 through the communication unit 110 for wireless communication. In step 15, the control unit 160 generates signal information and outputs the generated signal information to the second electronic device 200. The signal information includes specific information (e.g., frequency information), according to which the second electronic device 200 generates the signal to be output.

In step 17, the control unit 160 receives, through the sensor unit 120, the signal from the second electronic device 200, which was generated based, at least in part, on the signal information transmitted in step 15. In one embodiment, the signal is an acoustic/sound signal, which may include a spectrum of sound ranging from audible to inaudible frequencies and is obtained by microphones 121a and 121b constituting sensor unit 120. In another embodiment, the signal is a sinusoidal radio/electromagnetic signal, which may contain frequency information and is obtained by a receiving antenna constituting, e.g., the sensor unit 120 and/or communication unit 110.

In step 19, the control unit 160 determines the relative position/direction of the second electronic device 200 from the received signal. The control unit 160 may determine the relative position/direction of the second electronic device 200, i.e., the second electronic device 200's position with respect to the first electronic device 100, using one of a direction of arrival (DOA) estimation method, such as a time delay of arrival (TDOA) estimation method, a beam scanning method, and a generalized cross correlation-phase transform (GCC-PHAT) method. Examples of such methods were discussed above, and thus, a detailed description thereof is omitted here.

FIG. 4 is a flow chart of a method for an electronic device to determine a relative position/direction of another electronic device, according to another embodiment of the present disclosure. In step 31 of FIG. 4, it is determined if there has been an event requiring and/or requesting measurement of the relative position/direction of the second electronic device 200. If such an event occurs in step 31, the method proceeds to step 33, and otherwise, the method loops back to the start.

In step 33, the control unit 160 connects to the second electronic device 200 through the communication unit 110 for wireless communication. In step 35, the control unit 160 generates signal information and transmits the generated signal information to the second electronic device 200. In this embodiment, the control unit 160 determines a frequency band in which the signal generated by the second electronic device 200 should be output. Information about the determined frequency band is included in the specific information by which the second electronic device 200 will generate the signal to be output. In step 37, the control unit 160 receives the signal, which was generated, at least in part, based on the signal information transmitted in step 35, from the second electronic device 200 through the sensor unit 120. Here, the signal is an acoustic/sound signal, which may include a wide spectrum of sound ranging from audible to inaudible frequencies and is obtained by microphones 121a and 121b of the sensor unit 120. In other embodiments, the signal is a sinusoidal radio/electromagnetic signal, which may contain frequency information and may be obtained by a receiving antenna of the sensor unit 120 and/or communication unit 110.

In step 39, the control unit 160 checks/analyzes/processes the received signal. In this embodiment, the control unit 160 applies a band-pass filter (BPF) to the received signal to remove signal components outside of the frequency band determined in step 35. Next, in step 41, the control unit 160 determines the relative position/direction of the second electronic device 200 using the filtered signal. In step 41, the control unit 160 may determine the relative position/direction of the second electronic device 200, i.e., its position/direction with respect to the first electronic device 100, using one of a direction of arrival (DOA) estimation method, a time delay of arrival (TDOA) estimation method, a beam scanning method, and a generalized cross correlation-phase transform (GCC-PHAT) method. Examples of such methods were discussed above, and thus, a detailed description thereof is omitted here.

FIG. 5 is a flow chart of a method for an electronic device to determine the relative position/direction of another electronic device, according to still other embodiment of the present disclosure. Steps 51 and 53 of FIG. 5 are substantially the same as steps 31 and 33 of FIG. 4 and steps 11 and 13 of FIG. 3, and thus, a detailed description thereof is omitted here.

In step 55, the control unit 160 activates the sensor unit 120, by which, in step 57, the control unit 160 obtains an ambient signal(s) around the first electronic device 100, e.g., peripheral signals. Here, the obtained ambient signal(s) comprises a signal with a plurality of frequency components. In step 59, the control unit 160 analyzes the obtained ambient signal to determine the optimal frequency or frequency band for the signal intended to be received from the second electronic device 200, e.g., a receivable frequency/frequency band. In one embodiment, the control unit 160 analyzes the energy distribution of the ambient signal over the frequency domain to determine a frequency/frequency band with low or no energy. In step 61, the control unit 160 generates signal information including information about the optimal frequency/frequency band determined in step 59, and transmits the generated signal information to the second electronic device 200.

In step 63, the control unit 160 receives the signal generated by the second electronic device 200 based on the signal information transmitted in step 61, from the second electronic device 200 through the sensor unit 120. As discussed above, the signal may be an acoustic/sound signal and/or a sinusoidal radio/electromagnetic signal. Step 65 of FIG. 5 is performed in substantially the same way as step 41 of FIG. 4 and step 19 of FIG. 3, and thus, a detailed description thereof is omitted here.

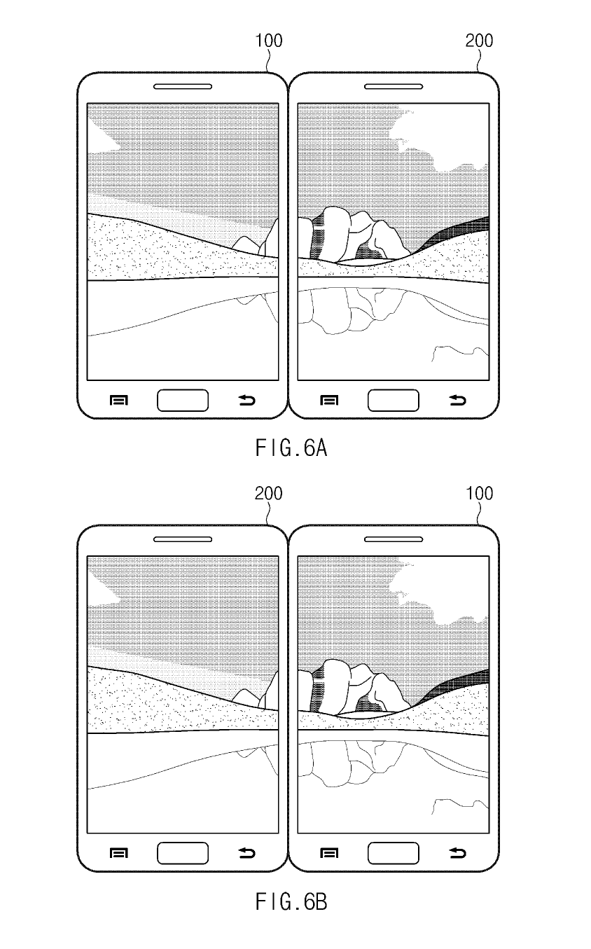

FIGS. 6A and 6B illustrate examples in which a position/direction determining method according to an embodiment of the present disclosure is used to display an image across the screens of several electronic devices.

FIGS. 6A and 6B show that, if the position/direction of the second electronic device 200 is determined by the first electronic device 100, the first electronic device 100 may provide image data (e.g., video data) to the second electronic device 200 so that an image/video is displayed spanning over the screens of both the first and second electronic devices 100 and 200. In FIG. 6A, the first and second electronic devices 100 and 200 are next to each other, with the first electronic device 100 on the left and the second electronic device on the right. Accordingly, a single image/video is displayed over the screens of both devices, the left side of the image/video on first electronic device 100 and the right side of the image/video on the second electronic device 200 in FIG. 6A.

In this embodiment, the first electronic device 100 determines the device type and screen pixel information of the second electronic device 200 (which may also be determined based on the device type alone). The first electronic device 100 suitably expands and splits the image/video based on, e.g., the screen pixel information of the first electronic device 100 and the second electronic device 200. Based on the relative position/direction information determined using an embodiment of the present disclosure, the first electronic device 100 transmits data representing the right-hand portion of the image/video to the second electronic device 200.

In embodiments of the present disclosure, the first electronic device 100 may also continuously and/or periodically monitor the relative position/direction of the second electronic device 200 to find out whether the relative position/direction of the second electronic device 200 has changed. For example, if, as illustrated in FIG. 6B, there is a change in the relative position/direction, namely, second electronic device 200 is now to the left of first electronic device 100, then the first electronic device 100 can appropriately change or reset the image/video data transmitted to the second electronic device 200. Based on the newly-determined relative position/direction information, the first electronic device 100 transmits data representing the left-hand portion of the image/video to the second electronic device 200 while the first electronic device 100 itself changes/resets to display the right-hand portion of the image/video, as illustrated in FIG. 6B.

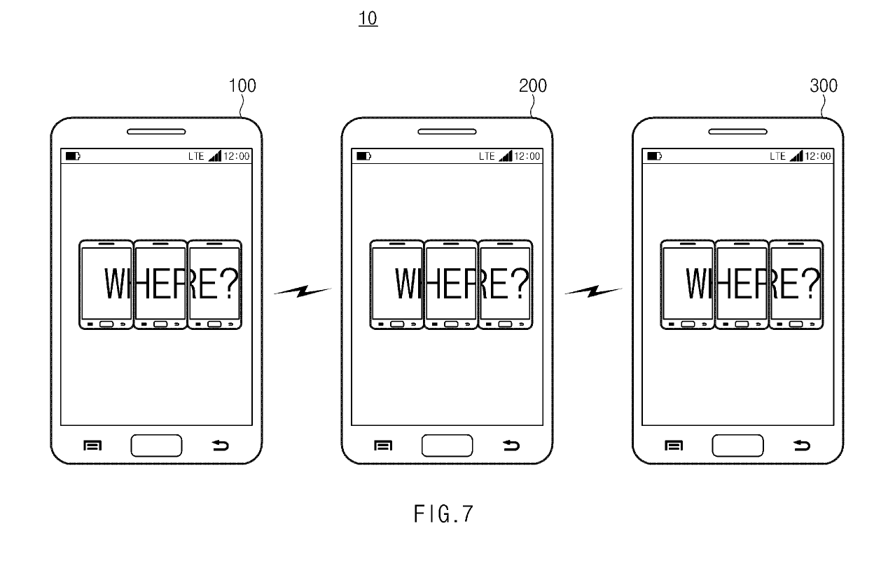

FIG. 7 is a diagram illustrating an example of a plurality of electronic devices determining their relative positions/directions, according to an embodiment of the present disclosure.

FIG. 7 shows a first electronic device 100, a second electronic device 200, and a third electronic device 300, each of which can determine relative positions/directions according to an embodiment of the present disclosure.

According to an embodiment of the present disclosure, the first electronic device 100, the second electronic device 200, and the third electronic device 300 are connected through a wireless network. The first electronic device 100 may generates and transmits first signal information and second signal information to the second electronic device 200 and the third electronic device 300, respectively. The first signal information contains information on a frequency/frequency band of a signal to be output from the second electronic device 200, and the second signal information contains information on a frequency/frequency band of a signal to be output from the third electronic device 300. The frequencies/frequency bands indicated by the first signal information and the second signal information are different from each other.

The first electronic device 100 receives a first signal, which is generated with the first signal information and is output from the second electronic device 200, and a second signal, which is generated with the second signal information and is output from the third electronic device 300, using two sensors. The first electronic device 100 determines the relative position/direction of the second electronic device 200 based on the first signal and the relative position/direction of the third electronic device 300 based on the second signal. The first electronic device 100 determines the angle of the direction of the second electronic device 200 with respect to itself, based on the first signal and the angle of the direction of the third electronic device 300 with respect to itself, based on the second signal.

The second electronic device 200 generates and transmits third signal information and fourth signal information to the first electronic device 100 and the third electronic device 300, respectively. The third and fourth signal information contain information (such as, e.g., different frequency/frequency bands) on the signals to be output by the first electronic device 100 and the third electronic device 300, respectively. The second electronic device 200 receives a third signal, generated with the third signal information and output from the first electronic device 100, and a fourth signal, which generated with the fourth signal information and output from the third electronic device 300, using two sensors. The second electronic device 200 determines the relative position/direction of the first electronic device 100 based on the third signal and the relative position/direction of the third electronic device 300 based on the fourth signal, including the angle of the direction of the first electronic device 100 with respect to the second electronic device 200 (based on the third signal) and the angle of the direction of the third electronic device 300 with respect to the second electronic device 200 (based on the fourth signal).

The second electronic device 200 transmits its relative position/direction information to the first electronic device 100. The first electronic device 100 determines relative positions/directions between the first electronic device 100, the second electronic device 200, and the third electronic device 300, using (a) the relative positions/directions it determined of the second electronic device 200 and the third electronic device 300 with respect to itself and (b) the relative positions/directions determined by the second electronic device 200 of the first electronic device 100 and the third electronic device 300 with respect to the second electronic device 200. The first electronic device 100 and the second electronic device 200 may be performing these operations concurrently.

According to another embodiment of the present disclosure, the first electronic device 100 generates first signal information, second signal information, and third signal information concerning the signals to be output from the first electronic device 100, the second electronic device 200, and the third electronic device 300, respectively.

The first electronic device 100 transmits a position determination request signal to the second electronic device 200 to ask the second electronic device 200 to measure the relative positions/directions of the first electronic device 100 and the third electronic device 300. When the position determination request signal is received, the second electronic device 200 connects wirelessly to the third electronic device 300 and a plurality of sensors provided in the second electronic device 200 are activated.

The first electronic device 100, the second electronic device 200, and the third electronic device 300 output first, second, and third signals in accordance with the first, second, and third signal information generated by the first electronic device 100, respectively. The first electronic device 100 receives and analyzes the second signal and the third signal to obtain information concerning the angle/direction of the second electronic device 200 and the third electronic device 300, respectively, with respect to itself. The first electronic device 100 determines the relative positions/directions of the second electronic device 200 and the third electronic device 300 with respect to the first electronic device 100 based on this information. The second electronic device 200 receives and analyzes the first signal and the third signal to obtain information concerning the angle/direction of the first electronic device 100 and the third electronic device 300, respectively, with respect to the second electronic device 200. The second electronic device 200 determines the relative positions/directions of the first electronic device 100 and the third electronic device 300 with respect to the second electronic device 200, based on this information.

The second electronic device 200 transmits its information on the relative positions/directions of the first electronic device 100 and the third electronic device 300 with respect to the second electronic device 200 to the first electronic device 100. With this information received from the second electronic device 200, the first electronic device 100 makes a final determination regarding the relative positions/directions between the first electronic device 100, the second electronic device 200, and the third electronic device 300.

Although the above description refers to an example in which the first electronic device 100 generates the signal information and determines the relative positions/directions of all of the electronic devices, but the present disclosure is not limited thereto. For example, the first electronic device 100 may generate first to third information, and at least one of the second electronic device 200 or the third electronic device 300 may be used to determine a position of the other electronic devices.

According to still another embodiment of the present disclosure, the first electronic device 100 is wirelessly connected to the second electronic device 200 and the third electronic device 300. The first electronic device 100 generates and transmits first signal information and second signal information to the second electronic device 200 and the third electronic device 300, respectively. The first electronic device 100 receives a first signal based on the first signal information from the second electronic device 200 and a second signal based on the second signal information from the third electronic device 300. The first electronic device 100 determines the relative positions/directions of the second electronic device 200 and the third electronic device 300 with respect to the first electronic device 100, based on the first signal and the second signal, respectively.

Here, if the determined relative position/direction of the third electronic device 300, for example, is beyond a certain threshold or criteria (for example, if the angle of the direction of the third electronic device 300 with respect to the first electronic device 100 is less than a critical value), the first electronic device 100 transmits a position determination request signal to the second electronic device 200 to ask the second electronic device 200 to measure the relative position/direction of the third electronic device 300. When the position determination request signal is received, the second electronic device 200 connects wirelessly to the third electronic device 300 and activates a plurality of sensors provided in the second electronic device 200. The second electronic device 200 generates and transmits third signal information and fourth signal information to the first electronic device 100 and the third electronic device 300, respectively. The second electronic device 200 receives a third signal based on the third signal information from the first electronic device 100 and a fourth signal based on the fourth signal information from the third electronic device 300. The second electronic device 200 determines the relative positions/directions of the first electronic device 100 and the third electronic device 300, based on the third signal and the fourth signal, respectively. The second electronic device 200 may determine information concerning the angle of the direction of the first electronic device 100 with respect to the second electronic device 200 and the angle of the direction of the third electronic device 300 with respect to the second electronic device 200.

The second electronic device 200 transmits, to the first electronic device, its determined positions/directions of the first electronic device 100 and the third electronic device 300 relative to the second electronic device 200. With this information received from the second electronic device 200, the first electronic device 100 makes a final determination concerning the relative positions/directions between the first electronic device 100, the second electronic device 200, and the third electronic device 300. For convenience of description, examples for determining relative positions/directions between two or three electronic devices have been described, but the present disclosure may also be applied to determine relative positions/directions between four or more electronic devices. Similarly, while the above description refers to an example in which the position determination request signal is transmitted from the first electronic device 100 to the second electronic device 200, the present disclosure is not limited thereto. For example, according to other embodiments of the present disclosure, the first electronic device 100 may randomly select one or more electronic devices to which the position determination request signal will be transmitted.

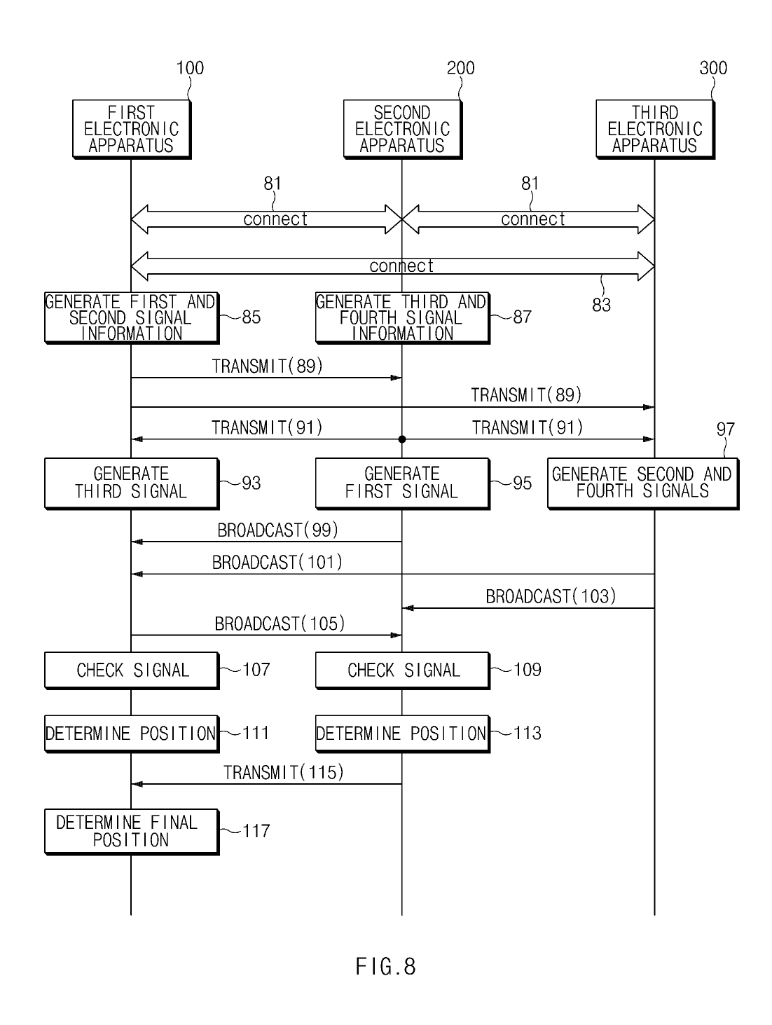

FIG. 8 is a flow chart illustrating a method of determining relative positions/directions of a plurality of electronic devices, according to an embodiment of the present disclosure.

Referring to FIGS. 7 and 8, in step 81, the first electronic device/apparatus 100 wirelessly connects to the second electronic device/apparatus 200 and the second electronic device 200 wirelessly connects to the third electronic device/apparatus 300. In step 83, the first electronic device 100 connects wirelessly to the third electronic device 300.

In step 85, the first electronic device 100 generates first signal information and second signal information which are transmitted to the second electronic device 200 and the third electronic device 300, respectively, in step 89. In step 87, the second electronic device 200 generates third signal information and fourth signal information, which are transmitted to the first electronic device 100 and the third electronic device 300, respectively, in step 91.

In step 93, the first electronic device 100 generates a third signal based on the third signal information received from the second electronic device 200 in step 91. In step 95, the second electronic device 200 generates a first signal based on the first signal information received from the first electronic device 100 in step 89. In step 97, the third electronic device 300 generates a second signal and a fourth signal based on the second signal information and the fourth signal information received from the first electronic device 100 and the second electronic device 200 in steps 89 and 91, respectively.

In step 99, the second electronic device 200 broadcasts the generated first signal, and in step 101, the third electronic device 300 broadcasts the generated second signal, both of which are obtained by the first electronic device 100. In step 103, the third electronic device 300 broadcasts the generated fourth signal, and in step 105, the first electronic device 100 broadcasts the generated third signal, both of which are obtained by the second electronic device 200. Of course, the first signal and the second signal may be received and, thus, also obtained by the second electronic device 200, and the third and fourth signals may be received and, thus, also obtained by the first electronic device 100. Here, the description focuses on the details directly pertinent and/or relevant to this embodiment of the present disclosure and, accordingly, since the first signal and the second signal were based on the first and second signal information generated by the first electronic device 100, their being obtained by the first electronic device 100 is described, and since the third signal and fourth signals were based on the third and fourth signal information generated by the second electronic device 200, their being obtained by the second electronic device 200 is described.

In step 107, the first electronic device 100 checks/analyzes/processes the first signal and the second signal broadcast by the second electronic device 200 and the third electronic device 300, respectively. Similarly, in step 109, the second electronic device 200 checks/analyzes/processes the third signal and the fourth signal broadcast by the first electronic device 100 and the third electronic device 300, respectively. In step 111, the first electronic device 100 determines the relative positions/directions of the second electronic device 200 and the third electronic device 300. Similarly, in step 113, the second electronic device 200 determines the relative positions/directions of the first electronic device 100 and the third electronic device 300. Here, the first electronic device 100 and the second electronic device 200 may perform steps 111 and 113, respectively, using one of a direction of arrival (DOA) estimation method, a time delay of arrival (TDOA) estimation method, a beam scanning method, and a generalized cross correlation-phase transform (GCC-PHAT) method.

In step 115, the second electronic device 200 transmits to the first electronic device the relative positions/directions it determined of the first electronic device 100 and the third electronic device 300. In step 117, the first electronic device 100 makes a final determination of the relative positions/directions between the first electronic device 100, the second electronic device 200, and the third electronic device 300, based on the relative positions/directions it determined in step 111 and the relative positions/directions it received from the second electronic device 200 in step 115. The above description has referred to an example in which the relative positions/directions of the second electronic device 200 and the third electronic device 300 are determined by the first electronic device 100, the positions of the first electronic device 100 and the third electronic device 300 are determined by the second electronic device 200, and then the first electronic device makes a final determination using those two determinations. However, the present disclosure is not limited to this example, and, in other embodiments, each of the electronic devices may be configured to execute their own functions in a concurrent and independent manner, the afore-described operations may be performed in a different order, and/or any one or more of the electronic devices may generate signal information.

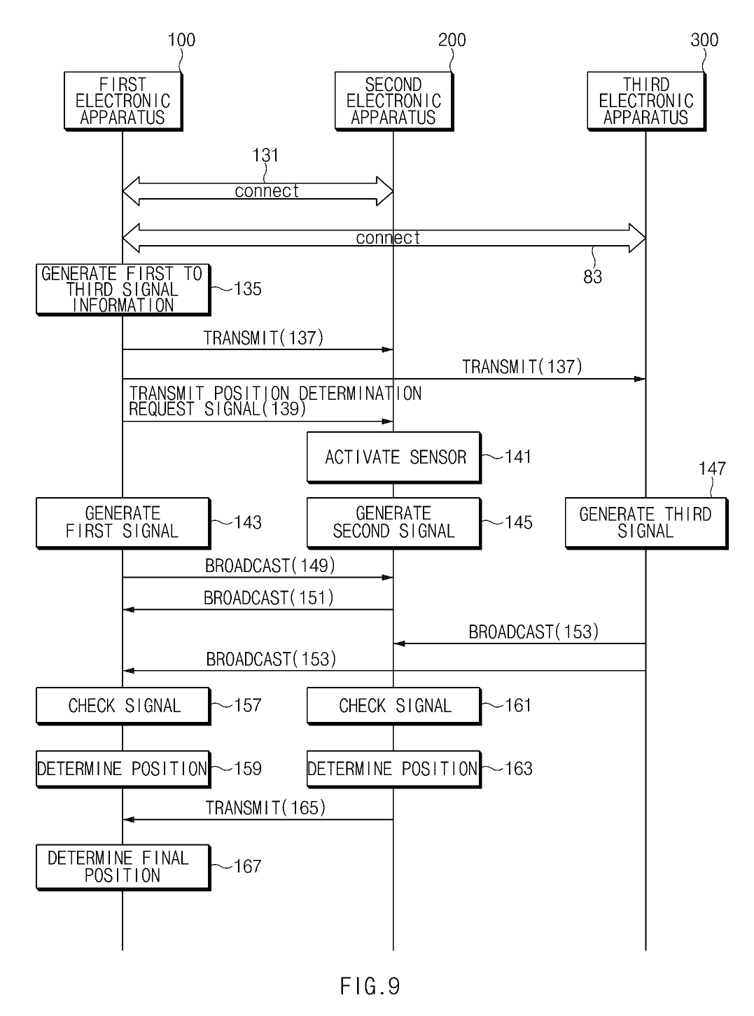

FIG. 9 is a flow chart illustrating a method of determining relative positions/directions of a plurality of electronic devices, according to another embodiment of the present disclosure.

In step 131 of FIG. 9, the first electronic device 100 connects wirelessly with the second electronic device 200, and in step 133, the first electronic device 100 connects wirelessly with the third electronic device 300. In step 135, the first electronic device 100 generates first, second, and third signal information, which are to be used to generate the specific signal to be output from the first electronic device 100, the second electronic device 200, and the third electronic device 300, respectively. Here, the first to third signal information may contain specific information on, for example, the frequencies/frequency bands of the signals which will be respectively output from the first electronic device 100, the second electronic device 200, and the third electronic device 300.

In step 137, the first electronic device 100 transmits the second signal information and the third signal information to the second electronic device 200 and the third electronic device 300, respectively. In step 139, the first electronic device 100 transmits a position determination request signal to the second electronic device 200, asking the second electronic device 200 to determine the relative positions/directions of the first electronic device 100 and the third electronic device 300. The first and third signal information may be transmitted with the position determination request to the second electronic device 200. When the position determination request signal is received, the second electronic device 200 activates at least two of its own sensors in step 141.

In step 143, the first electronic device 100 generates the first signal based on the first signal information; in step 145, the second electronic device 200 generates the second signal based on the second signal information; and, in step 147, the third electronic device 300 generates the third signal based on the third signal information.

In step 149, the first electronic device 100 broadcasts the first signal (which is obtained by the second electronic device 200); in step 151, the second electronic device 200 broadcasts the second signal (which is obtained by the first electronic device 100); and in step 153, the third electronic device 300 broadcasts the third signal (which is obtained by the first electronic device 100 and the second electronic device 200). While, for convenience of description, the present disclosure has referred to an example in which the first electronic device 100, the second electronic device 200, and the third electronic device 300 generate one signal each and broadcasts them to other electronic devices, this is just one of the possible embodiments of the present disclosure. For example, in an alternative embodiment, one or more of the electronic devices may be configured to generate and output a plurality of signals.

In step 157, the first electronic device 100 checks/analyzes/processes the second and third signals output from the second electronic device 200 and the third electronic device 300, respectively. In step 159, the first electronic device 100 determines the relative positions/directions of the second electronic device 200 and the third electronic device 300 based on the second and third signals, respectively. Similarly, in step 161, the second electronic device 200 checks/analyzes/processes the first signal and the third signal output from the first electronic device 100 and the third electronic device 300, respectively, and, in step 163, determines the relative positions/directions of the first electronic device 100 and the third electronic device 300 based on the first and third signals, respectively. As stated above, the determinations in steps 159 and 163 may be made using one of a direction of arrival (DOA) estimation method, a time delays of arrival (TDOA) estimation method, a beam scanning method, and a generalized cross correlation-phase transform (GCC-PHAT) method.

In step 165, the second electronic device 200 transmits to the first electronic device 100 its determined relative positions/directions of the first electronic device 100 and the third electronic device 300. In step 167, the first electronic device 100 makes a final determination regarding the relative positions/directions between the first electronic device 100, the second electronic device 200, and the third electronic device 300, based on the relative positions/directions of the second electronic device 200 and the third electronic device 300 it determined in step 159 and the relative positions/directions of the first electronic device 100 and the third electronic device 300 determined by the second electronic device 200 in step 163, and then transmitted in step 165.

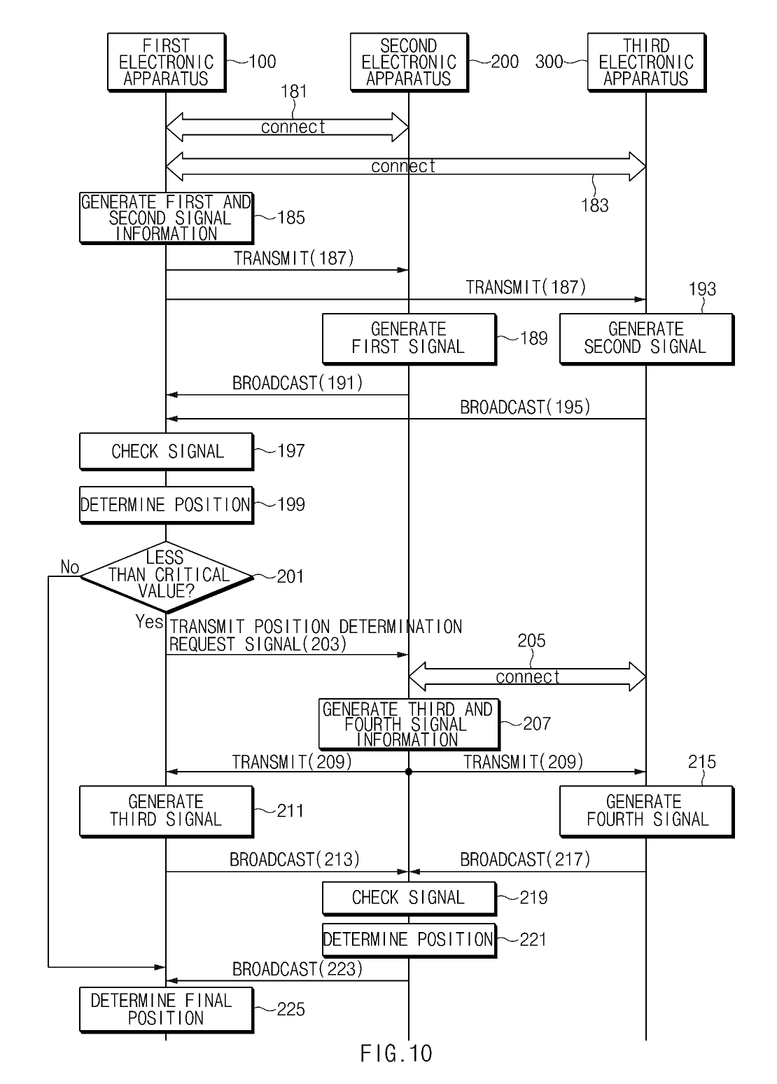

FIG. 10 is a flow chart illustrating a method of determining relative positions/directions of a plurality of electronic devices, according to still another embodiment of the present disclosure.

Steps 181 and 183 of FIG. 10 are substantially the same as steps 131 and 83 of FIG. 9, and thus, a detailed description thereof is omitted here.

In step 185, the first electronic device 100 generates first signal information and second signal information, which are transmitted to the second electronic device 200 and the third electronic device 300, respectively, in step 187. In step 189, the second electronic device 200 generates a first signal based on the first signal information, and, in step 191, broadcasts the first signal, which is obtained by the first electronic device 100. In step 193, the third electronic device 300 generates a second signal based on the second signal information, and, in step 195, broadcasts the second signal, which is also obtained by the first electronic device 100.

In step 197, the first electronic device 100 checks/analyzes/processes the first and second signal and, in step 199, determines the relative positions/directions of the second electronic device 200 and the third electronic device 300 using any of the methods as discussed above. In step 201, the first electronic device 100 checks whether or not the determined relative position/direction of the third electronic device 300 is beyond a certain threshold or criteria (for example, whether or not the angle of the direction of the third electronic device 300 with respect to the first electronic device 100 is less than a critical value). If the determined position/direction of the third electronic device 300 is below/within the certain threshold/criteria in step 201, the method proceeds to step 225.

If the determined position/direction of the third electronic device 300 is above/outside the certain threshold/criteria in step 201, the method proceeds to step 203, in which the first electronic device 100 transmits a position determination request signal asking the second electronic device 200 to determine the relative positions/directions of the first electronic device 100 and the third electronic device 300, i.e., their positions/directions with respect to the second electronic device 200. When the position determination request signal is received, the second electronic device 200 connects wirelessly with the third electronic device 300 and activates its own plurality of sensors. In step 207, the second electronic device 200 generates third signal information and fourth signal information, which are transmitted to the first electronic device 100 and the third electronic device 300, respectively, in step 209.

In step 211, the first electronic device 100 generates a third signal based on the third signal information and, in step 213, broadcasts the third signal, which is obtained by the second electronic device 200. Similarly, in step 215, the third electronic device 300 generates a fourth signal based on the fourth signal information and in step 217, broadcasts the fourth signal, which is obtained by the second electronic device 200.

In step 219, the second electronic device 200 checks/analyzes/processes the obtained third and fourth signals and, in step 221, determines the relative positions/directions of the first electronic device 100 and the third electronic device 300 using any of the previously discussed methods. In step 223, the second electronic device 200 transmits to the first electronic device 100 the relative positions/directions of the first electronic device 100 and the third electronic device 300 it determined in step 221. In step 225, the first electronic device 100 makes a final determination regarding the relative positions/directions between the first electronic device 100, the second electronic device 200, and the third electronic device 300.

Certain aspects of the present disclosure can be implemented with computer readable code stored on a non-transitory computer readable recording medium. A non-transitory computer readable recording medium is any data storage device that can store data which can be thereafter read by a computer system. Examples of a non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over a network of coupled computer systems so that the computer readable code is stored and executed in a distributed fashion. In addition, functional programs, code, and code segments for implementing aspects of the present disclosure can be easily construed by programmers skilled in the art to which the present disclosure pertains.

Various embodiments of the present disclosure described above involve, to some extent, the processing of input data and the generation of output data. This input data processing and output data generation may be implemented in hardware or software in combination with hardware. For example, specific electronic components may be employed in a mobile device or similar or related circuitry in the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory computer- and/or processor-readable mediums as described above.

While the present disclosure has been shown and described with reference to various embodiments thereof, it will be understood by those skilled in the art that various changes and/or modifications in form and details may be made therein without departing from the spirit and scope of the present disclosure as defined by the appended claims and their equivalents.

What is claimed is:

1. An electronic device capable of determining a relative position of at least one other electronic device, comprising:
a communication unit;
at least two microphones; and
a control unit which generates signal information by which another electronic device may generate an output signal to be detected by the microphones, controls the communication unit to transmit the signal information to the other electronic device, and, if the output signal is obtained by the microphones, determines a relative position of the other electronic device, based on the output signal obtained by the sensor unit.

2. The electronic device of claim 1, wherein the signal information comprises frequency information for the signal to be output from the other electronic device.

3. The electronic device of claim 2, wherein the frequency information comprises an indication of a frequency band for the signal to be output from the other electronic device.

4. The electronic device of claim 1, wherein the control unit generates the signal information based on a property of an ambient signal obtained through the microphones.

5. The electronic device of claim 1, wherein the control unit generates different signal information for a plurality of other electronic devices of which the electronic device will determine the relative position.

6. The electronic device of claim 5, wherein the control unit generates a position determination request signal asking for a first electronic device to determine a relative position of at least one second electronic device.

7. The electronic device of claim 6, wherein the control unit makes a final determination of the relative positions of the first electronic device and the at least one second electronic device, at least partially based on the determined relative position of the at least one second electronic device to the first electronic device, which was provided pursuant to the position determination request signal.

8. The electronic device of claim 1, wherein the control unit determines a relative position of the other electronic device using one of a direction of arrival (DOA) estimation method, a time delay of arrival (TDOA) estimation method, a beam scanning method, and a generalized cross correlation-phase transform (GCC-PHAT) method.

9. The device of claim 1, wherein the electronic device further comprises an antenna.

10. A method for an electronic device to determine a relative position of at least one other electronic device, comprising:
generating, by the electronic device, signal information by which another electronic device may generate an output signal to be detected by the electronic device;
transmitting the signal information to the other electronic device;
receiving the output signal generated using the signal information from the other electronic device; and
determining a relative position of the other electronic device based on the received output signal.

11. The method of claim 10, wherein the signal information comprises frequency information for the signal to be output from the other electronic device.

12. The method of claim 11, wherein the frequency information comprises an indication of a frequency band for the signal to be output from the other electronic device.

13. The method of claim 10, wherein the signal information is generated based on a property of an ambient signal obtained by at least two sensors.

14. The method of claim 10, wherein generating the signal information comprises:
generating different signal information for a plurality of other electronic devices of which the electronic device will determine the relative position.

15. The method of claim 14, further comprising:
generating and transmitting a position determination request signal asking for a first electronic device to determine a position of at least one second electronic device;
receiving, from the first electronic device, a relative position/direction of the at least one second electronic device with respect to the first electronic device, in response to the position determination request signal; and
making a final determination regarding the relative positions of the first electronic device and the at least one second electronic device, based on the relative position determined by the electronic device and the received relative position determined by the first electronic device.

16. The method of claim 14, further comprising:
generating and transmitting a position determination request signal to a first electronic device, when a relative position of at least one second electronic device of the plurality of devices receiving signal information is not determined.

17. A non-transitory computer-readable storage medium having one or more instructions which, when executed by a processor of an electronic device, causes the electronic device to perform the following steps:
generating, by the electronic device, signal information by which another electronic device may generate an output signal to be detected by the electronic device;
transmitting the signal information to the other electronic device;
receiving the output signal generated using the signal information from the other electronic device; and
determining a relative position of the other electronic device based on the received output signal.
